(19) United States
(12) Patent Application Publication
(10) Pub. No.: US 2010/0042491 A1
(43) Pub. Date: Feb. 18, 2010

(54) INCENTIVE BASED SYSTEM AND METHODS FOR AUTO FINANCING

(75) Inventors: Teresa A. Halleck, Sacramento, CA (US); Curtis Dair, Sacramento, CA (US)

Correspondence Address: JOHN P. O'BANION;O'BANION & RITCHEY LLP, 400 CAPITOL MALL SUITE 1550, SACRAMENTO, CA, 95814, US

(73) Assignee: THE GOLDEN 1 CREDIT UNION, Sacramento, CA (US)

(21) Appl. No.: 12/533,934

(22) Filed: Jul. 31, 2009

Related U.S. Application Data
(60) Provisional application No. 61/085,380, filed on Jul. 31, 2008.

(51) Int. Cl. G06Q 40/00; G06Q 30/00; G06F 17/00; G06K 19/06

(52) U.S. Cl. 705/14.25; 705/38; 235/380; 235/493; 235/449

(57) ABSTRACT

A system and method for providing incentive-based auto financing is disclosed. The method includes the steps of providing a member database comprising a financial data relating to a plurality of members having at least a first loan, comparing the member financial data against a predetermined set of eligibility criteria to prescreen at least a portion of the plurality of members for inclusion in a second loan, and periodically evaluating the member financial data relating to the first loan. Points are assigned to the member financial data according to the evaluation that correlate to an interest rate reduction for the second loan based on the assigned points cumulating above a threshold level. The cumulated points, interest rate reduction, and a pre-approved limit may be encoded on a machine-readable card for use at a dealership.

### CROSS-REFERENCE TO RELATED APPLICATIONS

This application claims priority from U.S. provisional application Ser. No. 61/085,380 filed on Jul. 31, 2008, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to financing systems and methods, and more particularly to auto financing systems and methods.

2. Description of Related Art

With increased competition in auto finance, competitive pricing and loan programs become an important value proposition. Because indirect auto lending has become a commodity, dealers wield too much control of the auto financing decision. Accordingly, a product that drives members to demand a specific auto loan is of strategic benefit.

In addition, the dealer loan process can be cumbersome and also disadvantageous to an auto purchaser. When a dealer pulls the credit history of a potential buyer, they gain financial information that may work against the buyer in negotiating a price on the vehicle.

### BRIEF SUMMARY OF THE INVENTION

Accordingly, an object of the present invention is to provide a system wherein a member may buy down an already-competitive rate on a subsequent loan based on the member's performance on an existing loan, thus creating a compelling reason for the member to demand a particular loan.

Another object of the present invention is a system and method that offers a streamlined auto financing experience, wherein the buyer has a pre-approved loan prior to approaching a dealership, thus providing a hassle free, user-friendly process the member could use with little advance planning.

A system and method are disclosed for pre-authorizing a loan based on a member's performance on an existing loan. A point system is assigned based on member criteria such as enrollment into the program, payment history, electronic loan payments, options purchased with the loan, and future promotional criteria and that point system is then used to assign an incentive to the customer/member in the form of deductions for a lower interest rate.

An aspect of the invention is a method for facilitating a loan, comprising the steps of providing a first loan to a member, evaluating the member's performance of the loan, assigning points associated with the member based on the member criteria, and providing a subsequent loan at an interest rate deduction. The interest rate deduction is based on the member accumulating points in excess of a predetermined threshold number.

The one or more member criteria may comprise the member's payment history, options purchased with the first loan, signing up into the program, electronic loan payments, and future promotional criteria.

In addition, the method includes providing the member with a pre-approved loan limit for purchase at an auto dealer.

In a preferred embodiment, the method may further include the step of generating a card providing identifying information regarding the member and associated financial data, said associated financial data comprising the pre-approved loan limit. The identifying information may comprise a member number that may be used to locate said financial data.

In an alternative embodiment, the card comprises a magnetically readable card, and wherein the associated financial data is encoded on the magnetically readable card.

In another embodiment, the pre-approved loan limit is encoded on a magnetically readable card that can be taken to a dealership such that the dealer reads the magnetically readable card to check the member's pre-approval status without requiring the member to complete a loan application. Data relating to the interest rate reduction may also be encoded on the magnetically readable card. A website may also be provided wherein members and dealers may have limited access to member data such as the pre-approved limit, accumulated points, or interest rate buy-down options.

Another aspect is a system for providing auto financing. The system includes a member database comprising a financial data relating to a plurality of members having at least a first loan, a central processor coupled to the member database, the processor configured to retrieve and update data from said member database, and interface software coupled to the central processor, the interface software configured to provide access to at least a portion of said member database to one or more users. The system further includes a card generator coupled to the processor, the card generator being configured to generate a card providing identifying information regarding the member and associated financial data, wherein said financial data comprises a pre-approved loan limit for a second loan based on financial data relating to said first loan.

In one embodiment, card generator is configured to print a member number that may be used to locate said financial data.

In an alternative embodiment, the card generator comprises a magnetic card encoder coupled to the processor, the magnetic card encoder being configured to encode financial data relating to a member from the member database on to a magnetically readable card.

In one embodiment, the central processor is further configured to analyze said member financial data and assign points data to the member financial data, wherein the points data is assigned according to a predetermined table relating to each member's performance of the first loan, and wherein the central processor is configured to accumulate the points data and provide an interest rate reduction on the second loan based on the accumulated points achieving a threshold value.

In a preferred embodiment, the accumulated points data and interest rate reduction are configured to be encoded on the magnetically readable card.

In another embodiment, wherein the one or more users comprise one or more members, one or more dealers and one or more branch offices, wherein the interface software is configured to allow controlled access to the one or more users for viewing at least a portion of the member data.

In yet another embodiment, the central processor is configured to compare member financial data in said member database to a predetermined set of eligibility data to pre-screen members for said second loan.

In a further embodiment, the magnetically readable card is readable at an auto dealer to check the member's pre-approval status without requiring the member to complete a loan application.

Another aspect is a method for providing auto financing, comprising the steps of providing a member database comprising a financial data relating to a plurality of members having at least a first loan, comparing the member financial data against a predetermined set of eligibility criteria to prescreen at least a portion of the plurality of members for inclusion in a second loan, periodically evaluating the member financial data of the prescreened members, the member financial data relating to the first loan, assigning points to the member financial data according to said evaluation and providing an interest rate reduction for the second loan based on the assigned points cumulating above a threshold level.

In a preferred embodiment, the method includes the step of providing a pre-approved loan limit for the second loan based on financial data relating to said first loan. In one mode of the current embodiment, the method includes encoding data relating to said cumulative points, pre-approved loan limit, and interest rate reduction on a machine-readable card. The encoded machine readable card may be read at a dealership to process the second loan without requiring the member to apply for the second loan.

In another embodiment, the method includes the step of providing an interface configured to allow one or more members, one or more dealers and one or more branch offices, to access the at least a portion of the member database and view data relating wherein said interface software is configured to allow controlled access to the one or more users for viewing at least a portion of said member data.

In one embodiment, evaluating the member financial data relating to the first loan comprises evaluating the payment history on the first loan. In addition, providing a pre-approved loan limit for the second loan may comprise establishing a credit limit for a member, and subtracting the value of the first loan from the credit limit to obtain the pre-approved loan limit for the second loan.

Another aspect is a machine readable card, comprising encoded financial data associated with a member having a first loan with a financial institution, wherein the encoded financial data further comprises a pre-approved loan limit for a second loan with the financial institution, and wherein the pre-approved loan limit is a function of the member's credit history and the first loan.

The machine readable card may further include encoded financial data relating to an interest rate reduction for the second loan, wherein the interest rate reduction data is a function of the member's performance of the first loan.

In one embodiment, the interest rate reduction data is cumulated according to the member's payment history on the first loan.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 illustrates a method for providing incentive-based financing in accordance with the present invention.

FIG. 2 illustrates a system for performing the incentive-based financing method of FIG. 1.

FIG. 3 illustrates a method of providing a pre-approved loan limit via a magnetically readable card in accordance with the present invention.

FIG. 4 illustrates eligibility criteria for the method and system of the present invention.

FIG. 5 shows a method of determining available credit limit in accordance with the present invention.

FIG. 6 illustrates a machine-readable card in accordance with the present invention.

### DETAILED DESCRIPTION OF THE INVENTION

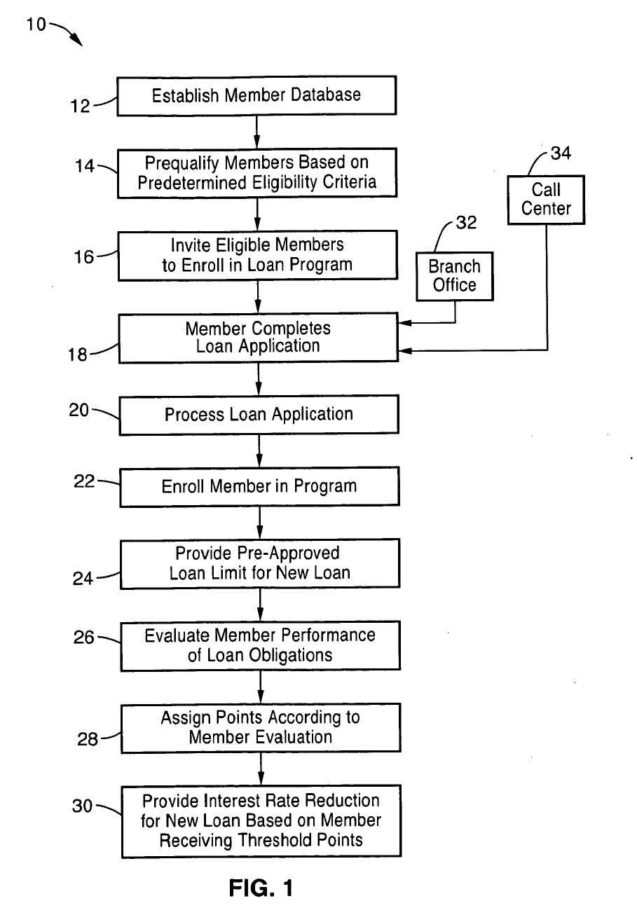

Referring more specifically to the drawings, for illustrative purposes the present invention is embodied in the apparatus generally shown in FIG. 1 through FIG. 6. It will be appreciated that the apparatus may vary as to configuration and as to details of the parts, and that the method may vary as to the specific steps and sequence, without departing from the basic concepts as disclosed herein.

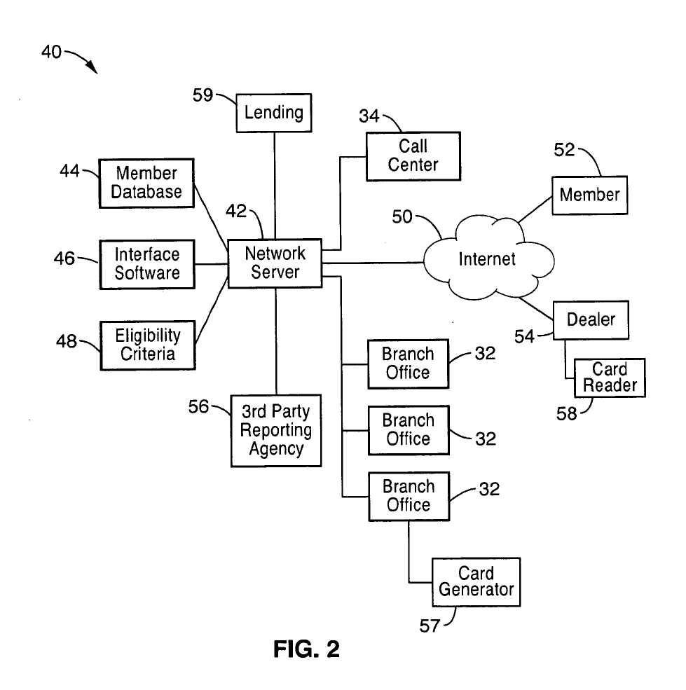

FIGS. 1 and 2 illustrate a method 10 and system 40 of the present invention for providing preapproval and incentives for a new loan based on a member's performance of a pre-existing or current loan. The present invention provides an incentive platform that rewards members with exceptional credit to finance future new car purchases.

Members may join the program in a number of different ways. First, members may be solicited to join based on an already established or establishing a member database at step 12. The database 44 (shown in FIG. 2) holds member personal info, financial data, and financing instruments associated with each of the individual members.

Members 52 are invited to apply for the program if they meet predetermined eligibility criteria. A pre-screening/pre-qualifying step is first performed at step 14 to determine which members will be invited to join.

Members 52 must meet predetermined eligibility criteria 48 (shown in system 40 in FIG. 2 and detailed in FIG. 4) prior to being solicited to participate in the program. Because the member is receiving a pre-approved loan that they can use to purchase any vehicle at any time, credit quality is an important factor. The initial eligibility criteria to participate in this program are preferably stringent. The initial eligibility criteria may be a function of one or more, and preferably all of the following:

1) Members having exceptional credit history 70 (e.g. Credit Tier A+),

2) Members having an existing loan 72 or loan paid off within the past 24 months.

3) The qualifying auto loan must have a threshold (e.g. 6 months) of payment history 74.

4) Members having no 30-day delinquencies 76 in the last 12 months or within the last 12 months of their prior paid-off auto loan,

5) Members having no bankruptcy filed, charge-off or repossession 78.

6) Enrollment in online program services 80.

Based on prescreening the above initial eligibility requirements, members may initially be invited to enroll in the program at step 16. Some of members 52 in database will not ultimately qualify for the program if they have not maintained a high enough credit threshold. Members eligible for the program may be further identified on a periodic (e.g. monthly) basis. Existing members may also be evaluated on a periodic basis to ensure they continue meeting the established eligibility criteria 48.

After the selected members receive the invitation to enroll, they must complete an enrollment form/application at step 18 located with or on the invitation (or online) and forward it back for processing at step 20 (which may be performed at a separate consumer lending department 59). The enrollment form may require the member 52 to authorize, as a condition for enrolling in the program, to periodically pull a credit file (e.g. with one or more third party credit reporting agencies 56 (e.g. Experian, Equifax, and/or Transunion) to ensure the member has maintained the threshold credit score and other requirements. The enrollment form may be sent or dropped off at the branch office 52, or directly to lending department 59.

It is also appreciated that the member 52 may be solicited to join or may ask to join via either communication with a branch office 32 or call center 34. A branch office 32 or call center 34 agent may assist in enrolling a member directly by having the member complete a loan application at step 18. The branch office or call center agent may defer to the member profile, showing the member's credit and payment history to prescreen the member based on the eligibility criteria 48.

The branch office 32 or call center 34 may also assist in processing the loan. For example, the member 52 may also wish to fund the program loan the same day that they accept their invitation. Alternatively, the member 52 may wish to finalize a new auto loan from a non-participating dealer. The member 52 may also refinance a loan originated through a different lender. The branch office 32 or call center may fax, email, or use other inter-office communication to provide the lending department 59 with appropriate information for loan disbursal (e.g. loan term, GAP, points used to buy down rate, automatic loan payment, first due date, etc.) If the member is in the branch office 32, they may wait a short period of time for this to be processed. Alternative, the call center 34 may call the member 52 back.

The interface software 46 available to the branch office 32 or call center 34 may be used to display particular details about program participants/members 52. A summary of the member's enrollment may be shown, and for convenience, a three field member identification number may be issued for participating members (e.g. 456758/2250/$35,000 may quickly relay that the Member # 456758, accumulated points of 2250, and available limit of $35,000). Other information that may be displayed includes the card number, program status (e.g. active, temporary opt out, permanent opt out, disqualified, etc.), setup and last update dates, loan limit (total and available), primary signer, secondary signer.

The branch office may also issue or update a membership card with available loan-limit and accumulated points with card generator 57.

Referring back to FIG. 1, the loan application is processed at step 20. The lending department 59 preferably processes the application and, if approved, enrolls the member into the program at step 20. Before approval, credit reports are obtained (via third party reporting agency 56) to ensure the member has threshold credit. As noted above, credit reports will be pulled periodically to ensure the member maintains credit. Once approved, the member is enrolled in the program and a preapproved loan limit is provided at step 24. Enrollment further includes sending a welcome package to the member 52 explaining the program, and providing a membership card with the preapproved loan limit.

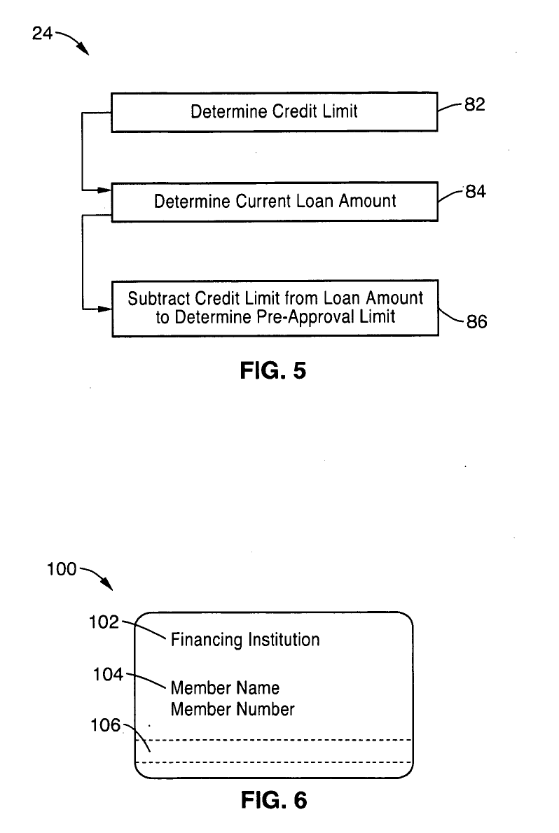

FIG. 5 illustrates a process for determining the pre-approved limit by determining the total credit limit 82, and subtracting the current loan amount 84 to get the available credit for a new loan at 86.

As shown in FIG. 6, a membership card 100 is issued that contains the member's name and account number on the front face. The membership card 100 may simply be a paper or plastic card with the front of the card being imprinted or impressed with identifying information relating to the member and the program, such as the financing institution 102 and member name and member number 104. With the member number 104, a dealer may be able to log on to the program website via internet 50, and find the member's pre-approved limit, accumulated points, and/or interest rate deduction for the new loan. The member program information may also be imprinted on to the card, wherein the dealer may still go to the website to confirm or update the financial information. The back of the card may have further imprinted information that provides instructions to both the member and/or dealer, e.g. how to look up the information on the webpage (provide webpage URL), etc.

In alternative embodiment, the financial data (e.g. account number, points, pre-approved limit, interest rate reduction and other data useful for the program) may be encoded on a magnetic stripe 106 located on the back of the card. The card 100 may be encoded with this information via a mag-stripe card reader/writer/encoder that encodes data on a stripe of magnetic oxide tape 106 that is laminated on a card. Alternatively, smart cards, optical cards, or other technologies can be put on cards as well (such as bar codes, touch memory, etc.).

The card 100 may be issued from the lending department 59, or be generated at the local branch via a card generator 57 (which may comprise a mag-stripe reader/encoder if the card has a magnetic strip) while the member waits (after approval from lending).

In addition, once enrolled, the program account information is prominently displayed in the member's online account. Account information such as available pre-approved credit amount, accumulated points and account status may be made available to the member 52, or dealer 54 via the internet 50. The interface software 46 (e.g. website, and/or software available at branch office 32 computers) is configured such that the individual or dealer member information is password protected, and only allow controlled access to member data relating to a particular member or dealer. The branch offices 32 may access the member database 44 directly through an intranet (not shown), or through the internet 50.

Members enrolled in the program will earn points for making on-time payments on their existing loan, purchasing certain insurance products (e.g. credit life, disability, mechanical breakdown) within 60 days of funding, and other milestones.

Although special opportunities to earn additional points may be offered in the future (at management's discretion), an exemplary points listing may be seen in Table 1.

As shown in Table 1, members may earn points for just enrolling in the program. The “instant gratification” provided to the member with points just for enrolling in the program provides an instant buy-in and commitment to the program by those members. Members may continue to accrue points by staying in the program and making their payments as agreed. Points may also be awarded for other purchased products, e.g. credit life, disability, MBI and GAP. Points may also be awarded for enrolling in online payment.

As shown in FIG. 1, the member performance (e.g. on-time payments, etc.) is evaluated (e.g. monthly) to update the member's accumulated points at step 26. This step may be performed by use of the central computer/processor or network server 42 querying the member database 44 for member payment activity, and assigning points to the member's profile at step 28 according to the values assigned in Table 1.

At step 30, the accumulated points can be redeemed to buy down the interest rate on the member's next new loan. Different interest rate reduction increments may be awarded according to preset criteria illustrated in Table 2.

For example, a 0.25% reduction may be awarded for 3000 accumulated points, and a 0.50% reduction may be awarded for 6000 accumulated points. Other increments and/or ratios may be provided at the lender's preference. For example, a 0.125% reduction may be awarded for 1500 accumulated points, and a 0.375% reduction may be awarded for 4500 accumulated points.

Thus, under Tables 1 and 2, a member can earn enough points to earn the 0.25% reduction in 17 months if they purchase all the indicated products.

The income statement impact of the reduced yield has been evaluated based on different “pull through” scenarios and deemed acceptable.

In a preferred embodiment, the member receives 500 points as a welcome reward for joining the program, and they are granted a “forever” pre-approval limit for future auto loans. It should be noted that the program preferably only rewards members with points for new auto loans. Therefore, although a used auto loan may qualify a member for the program, they may only earn rewards points for new auto loans with the credit union.

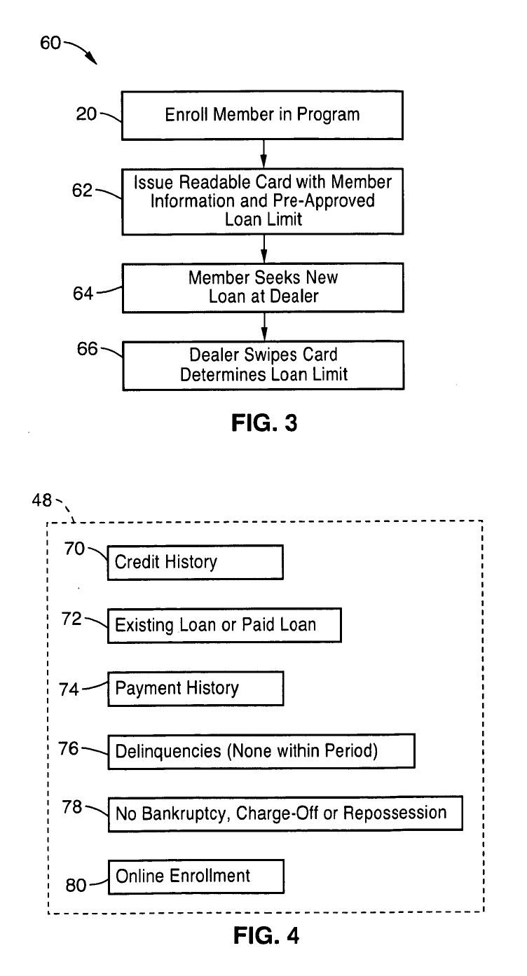

FIG. 3 illustrates the method 60 of the present invention from the member's perspective. At step 20, the member enrolls in the program, and is issued a readable card 100 with pre-approved loan limit at step 62. The member may then take the card to a participating dealer 54 of their choice for purchase of a new car at step 64. All the dealer 54 needs to do to verify the member has sufficient credit to purchase is swipe the card at step 66 with a card reader 58. Alternatively, the dealer 54 may enter the card number via online access to the internet 50, and get the pre-approved limit and interest rate (including interest rate reduction). In either case, the member is not required to fill out any loan approval documentation, or give the dealer their financial information, as they are already pre-approved for the purchase.

To ensure a “hassle free” experience, members may purchase a new auto from a participating auto dealership. For example, franchised “CUDL AutoSMART dealers” may be partners to implement this program.

A list of the participating dealers will be made available on the website for member identification. The use of these dealers allows members access to specified sales staff at the dealerships.

Once the member is ready to purchase their next new auto, members 52 simply contact a CUDL AutoSMART dealer 54 and make an appointment. A CUDL AutoSmart dealer is a recognized franchise dealership participating in the CUDL program, who has signed an agreement to provide a superior buying experience to the member.

This program is designed to allow members access to “hassle-free pricing” by providing them access to internet or fleet sales staff at the dealerships, but the price has not been pre-determined. Once the members show their membership card, they will avoid the hassle of having to apply for a loan—an experience very similar to a cash buyer. The dealer may confirm the member's eligibility in the program by accessing a special dealer website.

The website will show the member's approval limit, number of points available to buy down the interest rate, and all vesting requirements. If the new auto purchase is within the member's limit, the dealer prints loan documents to sign, and the member drives off the lot.

All loan paperwork may be processed through the CUDL system, eliminating the need for the member to return to a branch. Dealers will generally support the program because the members are pre-approved and the dealers know the credit union will purchase their Retail Installment Sales Contract (“RIC”), and they will receive a CUDL fee for processing the paperwork.

The program also allows members to take advantage of dealer rebates and promotions as long as members refinance their loan (which was made with a different lender) with the program within 90 days of purchase.

Members must have and maintain their high credit threshold to be eligible for this program, which guarantees them our best interest rate at the time of their purchase. The system 40 may periodically review the member's credit, and disqualify the member from the program for one or more of the following events: past due account, overdrawn status, changing in credit standing, change in eligibility status, etc. When a member is disqualified from the program, the accumulated points associated to them are removed, and the pre-approval limit will no longer be available. The lending department 59 will change the member's status and send a letter to the member stating that they have been removed from the program.

Once a program loan is paid off, the member has a specified period (e.g. 12 months) to purchase their next new auto and redeem their accrued points to buy down that interest rate. A new card 100 may be issued to the member 52 at that time showing an updated credit limit (as the loan was paid off), and total accumulated points. After 12 months, any unused accumulated points will be lost. However, the member is still enrolled in the program and can begin earning points with their next new auto purchase.

To automate the process, the network server 42 and interface software 46 may be configured to interface with the member database 44 to provide automatically generated letters to be sent to members 52 during different stages of the process. For example, the system may include an enrollment invitation letter, welcome letter, disqualification letter, reinstatement letter, modification letter, etc.

A summary of the benefits of the present invention include:

1) High eligibility standards help generate high quality new auto loans.

2) Points reward members who obtain auto financing from the program and make their payments.

3) The member is pre-approved for auto loan amounts up to pre-established limits. They never have to complete another auto loan application, assuming they maintain the eligibility criteria.

4) Pre-approval and partnering with select dealers provides a hassle-free, streamlined auto financing experience.

5) Members immediately earn points upon enrollment in the program.

6) Earned points are prominently displayed in members' online account.

7) Increased volume of quality auto loans help increase loan to assets ratio and improve the financial strength and stability of the credit union or financial institution.

Embodiments of the present invention are described with reference to flowchart illustrations of methods and systems according to embodiments of the invention. These methods and systems can also be implemented as computer program products. In this regard, each block or step of a flowchart, and combinations of blocks (and/or steps) in a flowchart, can be implemented by various means, such as hardware, firmware, and/or software including one or more computer program instructions embodied in computer-readable program code logic. As will be appreciated, any such computer program instructions may be loaded onto a computer, including without limitation a general purpose computer or special purpose computer, or other programmable processing apparatus to produce a machine, such that the computer program instructions which execute on the computer or other programmable processing apparatus create means for implementing the functions specified in the block(s) of the flowchart(s).

Accordingly, blocks of the flowcharts support combinations of means for performing the specified functions, combinations of steps for performing the specified functions, and computer program instructions, such as embodied in computer-readable program code logic means, for performing the specified functions. It will also be understood that each block of the flowchart illustrations, and combinations of blocks in the flowchart illustrations, can be implemented by special purpose hardware-based computer systems which perform the specified functions or steps, or combinations of special purpose hardware and computer-readable program code logic means.

Furthermore, these computer program instructions, such as embodied in computer-readable program code logic, may also be stored in a computer-readable memory that can direct a computer or other programmable processing apparatus to function in a particular manner, such that the instructions stored in the computer-readable memory produce an article of manufacture including instruction means which implement the function specified in the block(s) of the flowchart(s). The computer program instructions may also be loaded onto a computer or other programmable processing apparatus to cause a series of operational steps to be performed on the computer or other programmable processing apparatus to produce a computer-implemented process such that the instructions which execute on the computer or other programmable processing apparatus provide steps for implementing the functions specified in the block(s) of the flowchart(s).

Although the description above contains many details, these should not be construed as limiting the scope of the invention but as merely providing illustrations of some of the presently preferred embodiments of this invention. For example, the while the systems and methods of the present invention are particularly useful for auto loans, it is appreciated that the present invention may be used to facilitate a number of loan types, e.g. boat, home, line of credit, or the like. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Points Schedule

| | # of points earned |
|---|---|
| Approved and enrolled in Program | 500 |
| Monthly payments made as agreed | 100 points each |
| | timely payment |
| Electronic loan payment (60 days of loan | 500 |
| disbursement) | |
| Credit Life (within 60 days of disbursement) | 50 |
| Credit Disability (within 60 days of disbursement) | 50 |
| MBI (within 60 days of disbursement) | 100 |
| GAP (within 60 days of disbursement) | 100 |

TABLE 2
Interest Rate Buy-down

| Points Redeemed | Reward |
|---|---|
| 3,000 | .25% reduction |
| 6,000 | .50% reduction |

What is claimed is:

1. A method for facilitating a loan, comprising:
providing a first loan to a member;
evaluating the member's performance of the loan based on one or more member criteria associated with the first loan;
assigning points associated with the member based on the member criteria;
providing a second loan at an interest rate deduction;
wherein the interest rate deduction is based on the member accumulating points in excess of a predetermined threshold number.

2. A method as recited in claim 1, wherein the one or more member criteria comprises options purchased with the first loan.

3. A method as recited in claim 1, wherein the one or more member criteria comprises the member's payment history.

4. A method as recited in claim 1, further comprising:
providing the member with a pre-approved loan limit for purchase at an auto dealer.

5. A method as recited in claim 4, further comprising:
generating a card providing identifying information regarding the member and associated financial data, said associated financial data comprising the pre-approved loan limit.

6. A method as recited in claim 5, wherein the identifying information comprises a member number that may be used to locate said financial data.

7. A method as recited in claim 5, wherein the card comprises a magnetically readable card, and wherein the associated financial data is encoded on the magnetically readable card.

8. A method as recited in claim 5, wherein the auto dealer acquires the associated financial data to check the member's pre-approval status without requiring the member to complete a loan application.

9. A method as recited in claim 5, wherein the associated financial data comprises data relating to the interest rate reduction of the second loan.

10. A system for providing auto financing, comprising:
a member database comprising financial data relating to a plurality of members having at least a first loan;
a central processor coupled to said member database, said processor configured to retrieve and update data from said member database;
interface software coupled to the central processor, the interface software configured to provide access to at least a portion of said member database to one or more users; and
a card generator coupled to the processor, the card generator being configured to generate a card providing identifying information regarding the member and associated financial data;
wherein said financial data comprises a pre-approved loan limit for a second loan based on financial data relating to said first loan.

11. A system as recited in claim 10, wherein the card generator is configured to print a member number that may be used to locate said financial data.

12. A system as recited in claim 10, wherein the card generator comprises a magnetic card encoder coupled to the processor, the magnetic card encoder being configured to encode financial data relating to a member from the member database on to a magnetically readable card.

13. A system as recited in claim 10:
wherein the central processor is further configured to analyze said member financial data and assign points data to said member financial data;
said points data being assigned according to a predetermined table relating to each member's performance of the first loan;
wherein said central processor is configured to accumulate said points data and provide an interest rate reduction on said second loan based on said accumulated points achieving a threshold value.

14. A system as recited in claim 13, wherein the accumulated points data and interest rate reduction are configured to be encoded on a magnetically readable card.

15. A system as recited in claim 10, wherein the one or more users comprise one or more members, one or more dealers and one or more branch offices, wherein said interface software is configured to allow controlled access to the one or more users for viewing at least a portion of said member data.

16. A system as recited in claim 10, wherein the central processor is configured to compare member financial data in said member database to a predetermined set of eligibility data to pre-screen members for said second loan.

17. A system as recited in claim 12, wherein the magnetically readable card is readable at an auto dealer to check the member's pre-approval status without requiring the member to complete a loan application.

18. A method for providing auto financing, comprising:
providing a member database comprising a financial data relating to a plurality of members having at least a first loan;
comparing the member financial data against a predetermined set of eligibility criteria to prescreen at least a portion of the plurality of members for inclusion in a second loan;
periodically evaluating the member financial data of the prescreened members, the member financial data relating to the first loan;
assigning points to the member financial data according to said evaluation;
providing an interest rate reduction for the second loan based on the assigned points cumulating above a threshold level.

19. A method as recited in claim 18, further comprising:
providing a pre-approved loan limit for the second loan based on financial data relating to said first loan.

20. A method as recited in claim 19, further comprising:
encoding data relating to said cumulative points, pre-approved loan limit, and interest rate reduction on a machine-readable card.

21. A method as recited in claim 18, further comprising:
providing an interface configured to allow one or more members, one or more dealers and one or more branch offices, to access the at least a portion of the member database and view data relating wherein said interface software is configured to allow controlled access to the one or more users for viewing at least a portion of said member data.

22. A method as recited in claim 20, further comprising:
reading the encoded machine readable card at a dealership to process the second loan without requiring the member to apply for the second loan.

23. A method as recited in claim 18, wherein periodically evaluating the member financial data relating to the first loan comprises evaluating the payment history on the first loan.

24. A method as recited in claim 19, wherein providing a pre-approved loan limit for the second loan comprises:
establishing a credit limit for a member; and
subtracting a value of the first loan from the credit limit to obtain the pre-approved loan limit for the second loan.

25. A machine readable card, comprising:
encoded financial data associated with a member having a first loan with a financial institution;
wherein the encoded financial data further comprises a pre-approved loan limit for a second loan with the financial institution, said pre-approved loan limit being a function of the member's credit history and the first loan.

26. The machine readable card of claim 25, further comprising:
encoded financial data relating to an interest rate reduction for the second loan;
wherein the interest rate reduction data is a function of the member's performance of the first loan.

27. The machine readable card of claim 25, wherein the interest rate reduction data is cumulated according to the member's payment history on the first loan.
